(19) United States
(12) Patent Application Publication
(10) Pub. No.: US 2013/0013382 A1
(43) Pub. Date: Jan. 10, 2013

(54) SYSTEM AND METHOD FOR USE IN DELIVERING ENERGY TO AN ELECTRICALLY POWERED VEHICLE WITHIN A PARKING AREA

(76) Inventors: George William Alexander, Marietta, GA (US); John Christopher Boot, Sandy Springs, GA (US)

(21) Appl. No.: 13/177,322

(22) Filed: Jul. 6, 2011

(51) Int. Cl. G06Q 30/00

(52) U.S. Cl. 705/14.1

(57) ABSTRACT

A method of delivering energy to an electric vehicle with a charging device positioned within a parking area having a plurality of parking spaces is provided. The method includes calculating, by a parking validation device, a parking cost associated with a parking space used by the electric vehicle. An energy cost associated with an amount of energy delivered by the charging device to the electric vehicle is calculated. A retail transaction cost associated with an amount of retail purchases made at one or more commercial retail stores is calculated. The parking validation device determines whether to waive at least one of the calculated parking cost and the calculated energy cost based at least in part on the calculated retail transaction cost.

### BACKGROUND OF THE INVENTION

The subject matter disclosed herein relates generally to electrically powered vehicles and, more specifically, to systems and methods for use in delivering energy to an electrically powered vehicle within a parking area.

Electrically powered vehicles, including electric vehicles and plug-in hybrid electric vehicles, include electric motors powered by energy storage devices, such as batteries. An energy storage device is depleted of energy as the motor is operated, requiring the operator of the vehicle to recharge the energy storage device. As electric vehicles and/or hybrid electric vehicles gain popularity, an associated need to accurately manage delivery of electrical energy to them has increased. Moreover, a need to recognize revenue owed to the utility that provides the energy has been created by the increased use of such vehicles.

At least some parking areas are associated with a retail store to enable customers to park vehicles when shopping at the retail store. At least some known parking control systems monitor a parking garage gate to selectively provide access to the parking area. Such systems permit access to the parking garage by, for example, lifting the gate upon recognition of an identifier such as, for example an access card carried within a vehicle, a license plate of the vehicle, a finger print of a driver, and/or a voice pattern of the driver. A terminal reads the identifier from the access card and/or license plate, and/or obtains the finger print and/or voice pattern of the user, and communicates with a remote server. The server evaluates the identifier, and determines whether to permit access to the parking garage.

Moreover, at least some known parking systems provide data management services for managing revenue associated with one or more parking locations. Such systems receive revenue data for each parking location and store the data in a centralized database. An interface enables a user to view and/or manipulate the revenue data for each parking location or groups of parking locations over a network. Some such systems enable setup of differential pricing structures according to, for example, a location of the parking locations. However, generally such systems do not enable delivery of energy to an electric vehicle after access has been permitted and do not determine an energy cost associated with the energy delivery.

Accordingly, it is desirable to provide systems and methods for delivering energy to an electric vehicle while parked within a parking area, metering an amount of energy delivered to the electric vehicle, and adjusting an account according to a transaction amount that is based on the amount of energy delivered to the electric vehicle, a parking cost, and/or a retail transaction associated with the retail store.

### BRIEF DESCRIPTION OF THE INVENTION

In one aspect, a method of delivering energy to an electric vehicle with a charging device positioned within a parking area having a plurality of parking spaces is provided. The method includes calculating, by a parking validation device, a parking cost associated with a parking space used by the electric vehicle. An energy cost associated with an amount of energy delivered by the charging device to the electric vehicle is calculated. A retail transaction cost associated with an amount of retail purchases made at one or more commercial retail stores is calculated. The parking validation device determines whether to waive at least one of the calculated parking cost and the calculated energy cost based at least in part on the calculated retail transaction cost.

In another aspect, a power delivery system for use in charging an electric vehicle is provided. The power delivery system includes at least one charging device positioned within a parking area including a plurality of parking spaces. The charging device is configured to be electrically coupled to an electric vehicle for delivering energy to the electric vehicle. A parking validation device is coupled to the charging device and is configured to calculate a parking cost associated with a parking space used by the electric vehicle and calculate an energy cost associated with an amount of energy delivered to the electric vehicle. The parking validation device calculates a retail transaction cost associated with an amount of retail purchases made at one or more commercial retail stores, and determines whether to waive at least one of the calculated parking cost and the calculated energy cost based at least in part on the calculated retail transaction cost.

In yet another aspect, a parking validation device coupled to a plurality of charging devices for use in delivering power to an electric vehicle is provided. The parking validation device includes a processor that is coupled to a database. The processor is programmed to calculate a parking cost associated with a parking space used by the electric vehicle, and calculate an energy cost associated with an amount of energy delivered to the electric vehicle by a charging device. The processor calculates a retail transaction cost associated with an amount of retail purchases made at one or more commercial retail stores, and determines whether to waive at least one of the calculated parking cost and the calculated energy cost based at least in part on the calculated retail transaction cost.

### BRIEF DESCRIPTION OF THE DRAWINGS

FIG. 1 is a block diagram of an exemplary power delivery system for providing electricity to an electric vehicle.

FIG. 2 is a block diagram of an exemplary charging device that may be used with the power delivery system shown in FIG. 1.

FIG. 3 is an expanded block diagram of the power delivery system shown in FIG. 1.

FIG. 4 is a flow diagram of an exemplary method of delivering power to an electric vehicle that may be used with the system shown in FIG. 1.

### DETAILED DESCRIPTION OF THE INVENTION

The exemplary methods and systems described herein overcome at least some disadvantages of known parking monitoring systems by providing a charging device positioned within a parking area to selectively deliver power to an electric vehicle parked in the parking area. Moreover, the power delivery system described herein includes a parking validation system that determines an energy cost associated with delivery of energy to the electric vehicle, and determines a parking cost associated with use of the parking area by the electric vehicle. In addition, the parking validation device determines a retail transaction cost associated with purchase made by an owner of the electric vehicle at a retail store, and waives at least a portion of the energy cost and/or the parking cost based on the retail transaction cost. By providing a parking area that includes a charging device and a parking validation system that determines a parking cost, an energy cost, and a retail transaction cost, a customer of the retail store is incentivized to patronize the retail store and to utilize the parking area. As a result, a revenue generated by the parking area and charging device is facilitated to be increased.

In some embodiments, the term “electrically powered vehicle” refers generally to a vehicle that includes one or more electric motors that are used for propulsion. Energy used to propel electrically powered vehicles may come from various energy storage devices, such as, but not limited to, an on-board rechargeable battery, a capacitor, and/or an on-board fuel cell. In one embodiment, the electrically powered vehicle is a hybrid electric vehicle, which may include both an electric motor and a combustion engine. In another embodiment, an electrically powered vehicle is an electric vehicle, which may include only an electric motor for propulsion. Moreover, some electrically powered vehicles are capable of recharging the energy storage device from a power receptacle, such as a power outlet. Accordingly, the term “electrically powered vehicle” as used herein may refer to any vehicle that includes an energy storage device to which electrical energy may be delivered, for example, via a power grid.

In some embodiments, the term “parking area” refers generally to an area that includes a number of parking spaces. The parking spaces may be covered by, for example, a canopy, located within a parking garage, or located outside and uncovered. Moreover, parking spaces within such a parking area may be designated as energy delivery parking spaces and located within a proximity of an energy delivery point, or may be designated as non-delivery points. Accordingly, the term “parking area” as used herein may refer to a parking garage, an outdoor parking lot, or any suitable area in which to park a vehicle, such as an electric vehicle.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

Although described in connection with an exemplary parking and/or metering system environment, embodiments of the invention are operational with numerous other general purpose or special purpose computing system environments or configurations. The system environment is not intended to suggest any limitation as to the scope of use or functionality of any aspect of the invention. Moreover, the system environment should not be interpreted as having any dependency or requirement relating to any one or combination of components illustrated in the exemplary operating environment. Examples of well known systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more controllers, computers, or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein are not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a memory device, as described herein, includes a computer readable medium, such as, without limitation, random access memory (RAM), flash memory, a hard disk drive, a solid state drive, a diskette, a flash drive, a compact disc, a digital video disc, and/or any suitable device that enables a processor to store, retrieve, and/or execute instructions and/or data.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

An exemplary technical effect of the methods, systems, and computers described herein includes at least one of (a) receiving, by a charging station from the electric vehicle, a request to deliver power from the power supply to the electric vehicle; (b) receiving, by the charging station from the electric vehicle, a signal that is indicative of a unique identifier associated with the electric vehicle; (c) determining, by the charging station, whether the unique vehicle identifier is associated with a stolen electric vehicle; (d) delivering power, from the charging device to the electric vehicle, after determining the unique identifier is not associated with a stolen electric vehicle.

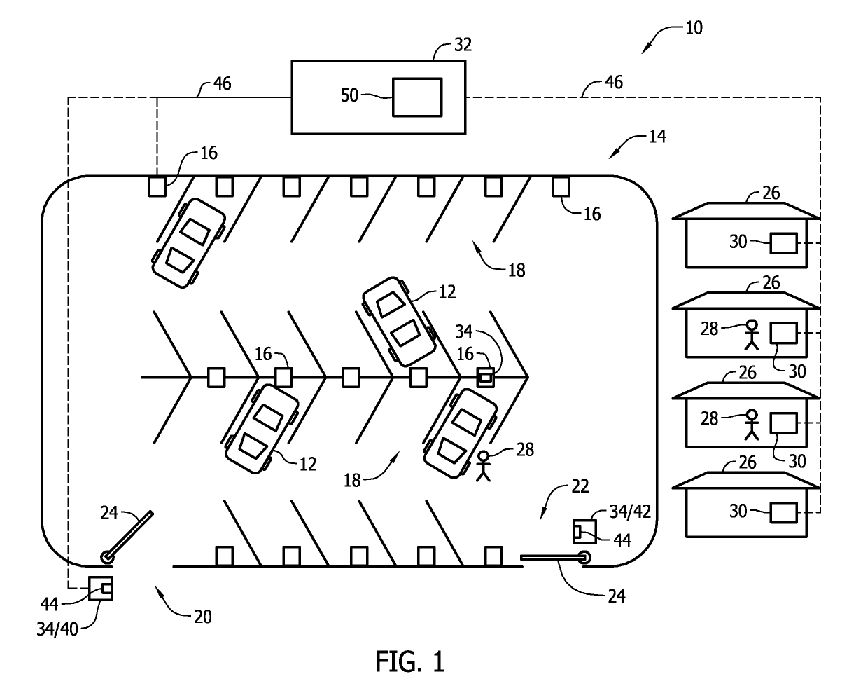

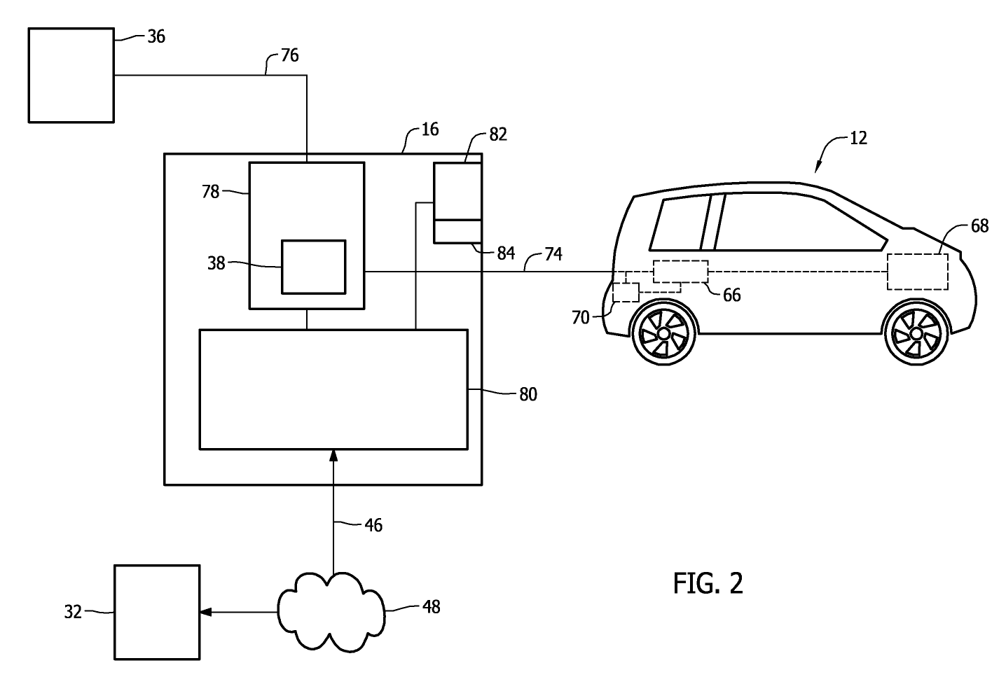

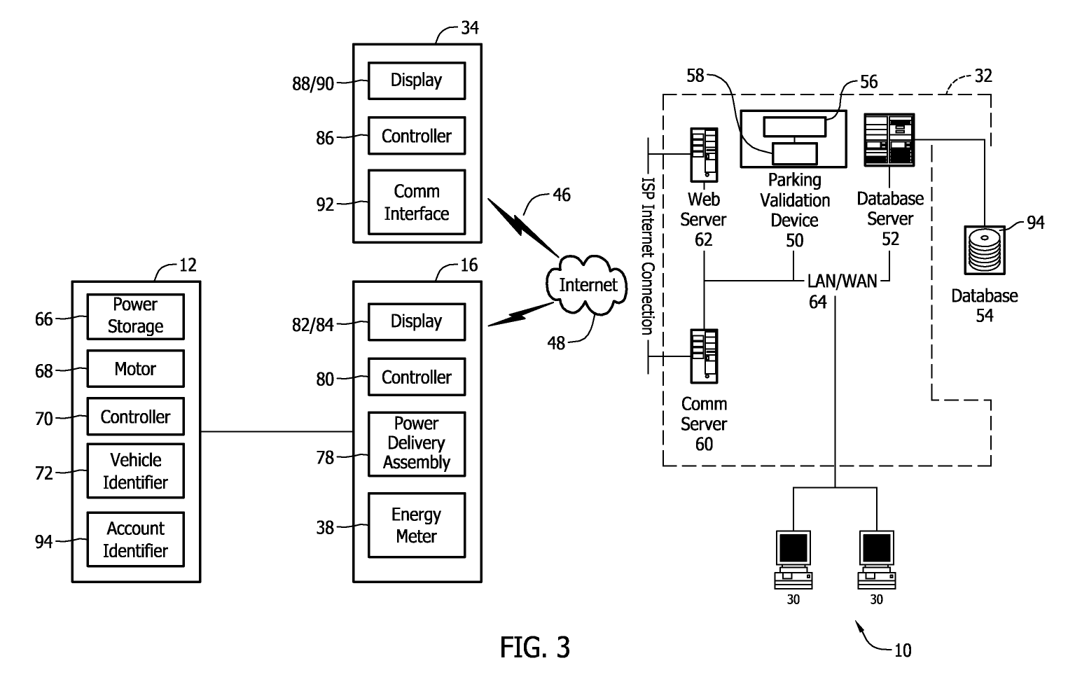

FIG. 1 is a block diagram of an exemplary power delivery system 10 for use in charging an electric vehicle 12 within a parking area 14. FIG. 2 is an expanded block diagram of an exemplary charging device 16 that may be used with power delivery system 10. FIG. 3 is an expanded block diagram of the power delivery system 10. In the exemplary embodiment, parking area 14 includes a plurality of parking spaces 18 that extend between an entrance area 20 and an exit area 22. A pair of access gates 24 are positioned with respect to entrance area 20 and exit area 22, respectively, to control access into, and out of, parking area 14. In the exemplary embodiment, one or more commercial retail stores 26 are positioned with respect to parking area 14 to enable a user, i.e. a customer 28, shopping at commercial retail stores 26 to use parking area 14 to park vehicles such as, for example, electric vehicle 12 within parking area 14. Each commercial retail store 26 includes a computing device 30 to determine a financial transaction associated with the purchase of goods and/or services by a customer from commercial retail store 26.

In the exemplary embodiment, power delivery system 10 includes one or more charging devices 16, a parking validation system 32, and one or more parking meters 34. Each charging device 16 is oriented with respect to one or more parking spaces 18 such that a charging device 16 is accessible by an electric vehicle 12 parked in a corresponding parking space 18. Charging device 16 is configured to selectively deliver electrical power from an electric power source 36 (shown in FIG. 2) to electric vehicle 12. In addition, each charging device 16 includes an energy meter 38 that tracks an amount of energy delivered to electric vehicle 12 to enable charging device 16 to determine an amount of energy delivered to electric vehicle 12. In the exemplary embodiment, each parking meter 34 determines a parking fee associated with a temporary use of parking area 14 by electric vehicle 12, and transmits a signal indicative of the determined parking fee to parking validation system 32.

In one embodiment, power delivery system 10 includes an entrance parking meter 40 positioned with respect to entrance area 20, and an exit parking meter 42 positioned with respect to exit area 22. Entrance parking meter 40 and exit parking meter 42 are each operatively coupled to a corresponding access gate 24 to selectively provide access into, and out of, parking area 14. In one embodiment, a plurality of parking meters 34 are positioned with respect to each parking space 18 to enable a customer to pay a determined parking fee associated with the use of a corresponding parking space 18. In another embodiment, charging device 16 includes parking meter 34 to enable customer 28 to access parking meter 34 via charging device 16. In addition, charging device 16 and parking meter 34 each may include a payment device 44 that enables customer 28 to process a payment associated with the calculated parking cost and/or the calculated energy costs via payment device 44.

Parking validation system 32 is communicatively coupled to each charging device 16, parking meter 34, and retail computing device 30 via a network link 46 that enables each charging device 16, parking meter 34, and retail computing device 30 to access parking validation system 32 over a network 48, such as the Internet and/or an intranet. In the exemplary embodiment, parking validation system 32 includes a parking validation device 50 that is connected to a database server 52 and a database 54 that contains information on a variety of matters such as, for example, account information related to electric vehicle 12, owner information of electric vehicle 12, parking fee information, energy fee information, and/or retail transactions associated with a customer. In the exemplary embodiment, parking validation device 50 includes a processor 56 and a memory device 58. Processor 56 is coupled to database server 52 to store and/or retrieve information associated with electric vehicle 12 and/or a customer 28 from database 54. In one embodiment, database 54 is stored on parking validation system 32 and is accessed directly via at least one charging device 16 and/or at least one parking meter 34. In an alternative embodiment, database 54 is stored remotely from parking validation system 32 and may be non-centralized.

During use of power delivery system 10 by customer 28, customer 28 parks electric vehicle 12 within parking area 14, charges electric vehicle 12 with charging device 16, and/or purchases goods and services from at least one commercial retail store 26. In the exemplary embodiment, parking validation device 50 calculates an energy cost associated with electric vehicle 12 based at least in part on the determined amount of energy delivered to electric vehicle 12 from charging device 16. Moreover, parking validation device 50 calculates a parking cost associated with electric vehicle 12 based at least in part on the determined parking fee associated with the parking space 18 occupied by electric vehicle 12. In one embodiment, parking validation device 50 calculates a parking cost based at least in part on a period of time a parking space 18 is occupied by electric vehicle 12. Alternatively, parking validation device 50 may calculate the parking cost based on any suitable fee basis such as, for example, a daily use fee, a monthly use fee, or an annual use fee.

In the exemplary embodiment, each retail computing device 30 transmits a signal indicative of a financial transaction associated with each purchase of goods and/or services by customer 28 to parking validation device 50. Parking validation device 50 calculates a retail transaction cost associated with customer 28 based at least in part on an amount of financial transactions by customer 28 during a period of time in which electric vehicle 12 is parked in parking area 14 and/or receiving energy from charging device 16.

In addition, parking validation device 50 determines whether to waive the calculated parking cost and/or the calculated energy cost associated with electric vehicle 12 based at least in part on the calculated retail transaction cost associated with customer 28. More specifically, parking validation device 50 determines that the calculated energy cost and/or the calculated parking costs to be waived upon determining that the calculated retail transaction costs is approximately equal to, or greater than, a predefined retail transaction cost. Alternatively, parking validation device 50 may determine that a predefined portion of the calculated energy cost and/or the calculated parking costs to be waived upon determining that the calculated retail transaction costs is approximately equal to, or greater than, a predefined retail transaction cost.

In the exemplary embodiment, parking validation system 32 includes parking validation device 50, database server 52, a communication server 60, and a web server 62. Device 50 and servers 52, 60, and 62 are coupled in a local area network (LAN) 64. Moreover, one or more retail computing devices 30 are also coupled to LAN 64 to enable communication with parking validation system 32. In one embodiment, customer 28 and/or retail computing devices 30 may access parking validation system 32 via web server 62 to access parking validation device 50.

In the exemplary embodiment, electric vehicle 12 includes at least one power storage device 66, such as a battery and/or any other electrical storage device, coupled to a motor 68. Electric vehicle 12 also includes a vehicle controller 70 operatively coupled to power storage device 66. In the exemplary embodiment, each electric vehicle 12 includes a unique vehicle identifier 72 that is used by charging device 16, parking meter 34, and/or parking validation device 50 to identify electric vehicle 12. Vehicle identifier 72 may be implemented as, for example, a radio frequency identification (RFID) chip. Alternatively, vehicle identifier 72 may be implemented as a tag that is embedded in any wired and/or wireless communication between charging device 16, parking meter 34, and electric vehicle 12.

In the exemplary embodiment, vehicle identifier 72 is linked in database 54 to an account associated with electric vehicle 12, in which an account balance is maintained including energy costs, parking costs, retail transaction costs, and payments that have been made to the account by customer 28.

In the exemplary embodiment, charging device 16 is removably coupled to power storage device 66 and to vehicle controller 70 with a power delivery conduit 74. Power delivery conduit 74 includes at least one conductor (not shown) for supplying electricity to power storage device 66, and at least one conductor (not shown) for transmitting data to, and receiving data from, vehicle controller 70. Vehicle controller 70 operates power storage device 66 to selectively receive power from charging device 16. In the exemplary embodiment, electric power source 36 is, for example, a generator, a battery, and/or any other device or system that provides electricity to charging device 16. Charging device 16 is electrically coupled to electric power source 36 with an electrical distribution bus 76. Electrical distribution bus 76 is a three-phase bus, such as a portion of an electric power grid of a utility company, providing alternating current (AC) power (i.e., AC current and voltage) to charging device 16. Alternatively, electrical distribution bus 76 may include any number of phases of AC power to charging device 16.

In the exemplary embodiment, charging device 16 includes a power delivery assembly 78 and a controller 80 coupled in operative communication with power delivery assembly 78. Controller 80 operates power delivery assembly 78 to selectively deliver electrical power from electric power source 36 to electric vehicle 12. In the exemplary embodiment, power delivery assembly 78 adjusts at least one characteristic of the volt-amperes received from electric power source 36 and converts the AC volt-amperes received from electric power source 36 to DC power for use in charging vehicle power storage device 66.

Charging device 16 also includes a display 82 and a user interface 84. Display 82, in the exemplary embodiment, includes a vacuum fluorescent display (VFD) and/or one or more light-emitting diodes (LED). Additionally or alternatively, display 82 may include, without limitation, a liquid crystal display (LCD), a cathode ray tube (CRT), a plasma display, and/or any suitable visual output device capable of displaying graphical data and/or text to customer 28. In an exemplary embodiment, a charging request, a charging level, a unit financial cost of electrical power, an accumulated electrical power financial cost incurred during charging, and/or any other information may be displayed to customer 28 on display 82. User interface 84 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables customer 28 to input data into controller 80 and/or to retrieve data from controller 80. In one embodiment, user interface 84 is integrated with display 82 such that user interface 84 is accessed by customer 28 via display 82. In the exemplary embodiment, customer 28 may input a predefined amount of electrical power demand and/or a predefined financial amount for use in charging electric vehicle 12 using user interface 84.

In the exemplary embodiment, each parking meter 34 includes a controller 86, a display 88, a user interface 90, and a communication interface 92. User interface 90 enables a customer 28 to access parking validation system 32 via parking meter 34 and request access to parking area 14. In addition, parking meter 34 presents a parking rate, a date and time, a parking cost, an account balance, and/or any other information to customer 28 on display 88.

During use, a customer 28 requests permission to access parking area 14, and/or a parking space 18 via user interface 90. Upon receiving an access request, parking meter 34 transmits, via communication interface 92, a verification request to parking validation system 32 to determine an owner account associated with electric vehicle 12 and/or customer 28. In the exemplary embodiment, parking validation system 32 determines an owner account associated with electric vehicle 12, and determines a unique account identifier 94 associated with the owner account. Parking validation system 32 transmits a verification message including the owner account and account identifier 94 to parking meter 34. Parking meter 34 presents account identifier 94 to customer 28, and permits access to parking area 14 and/or parking space 18. In one embodiment, electric vehicle 12 may be permitted entrance into parking area 14 after customer 28 inputs a predefined code and/or account number via user interface 90. Alternatively, parking meter 34 may transmit a verification request including vehicle identifier 72 to parking validation system 32. Parking validation system 32 may determine an owner account associated with the predefined account number and/or vehicle identifier 72.

In the exemplary embodiment, parking meter 34 presents a ticket and/or a card to customer 28 including account identifier 94. Alternatively, parking validation system 32 may transmit a notification message, such as an email message, a mobile text message, or any other wired and/or wireless communication message, that includes account identifier 94 to customer 28 via communication server 60.

Parking meter 34 also determines a parking fee associated with account identifier 94 based at least in part on the use of parking area 14 by electric vehicle 12, and transmits a signal indicative of the determined parking fee to parking validation system 32. Parking validation system 32 calculates a parking cost associated with the owner account and/or account identifier 94 based at least in part on the determined parking fee.

When customer 28 wishes to charge electric vehicle 12 with charging device 16, customer 28 connects electric vehicle 12 to power delivery conduit 74 and enters account identifier 94 via user interface 84 to request delivery of energy. Charging device 16 transmits a verification message including account identifier 94 and/or vehicle identifier 72 to parking validation system 32 to determine an owner account associated with account identifier 94 and/or vehicle identifier 72. In one embodiment, customer 28 inserts the card including account identifier 94 into charging device 16 to request an energy delivery. In the exemplary embodiment, parking validation device 50 verifies the owner account associated with account identifier 94 and/or vehicle identifier 72 and transmits a verification message to charging device 16.

Upon receiving the verification message, charging device 16 delivers energy to electric vehicle 12, determines an energy fee associated with the delivered energy, and transmits a signal indicative of the determined energy fee to parking validation device 50. Parking validation device 50 calculates an energy cost associated with owner account and/or account identifier 94 based at least in part on the determined energy fee.

In the exemplary embodiment, when customer 28 wishes to purchase goods and/or services from commercial retail stores 26, customer 28 may input account identifier 94 into retail computing device 30 such that the financial transaction is associated with owner account and/or account identifier 94. Parking validation system 32 transmits a retail transaction verification request including financial transactions associated with account identifier 94 to each commercial retail store 26. Parking validation device 50 receives a signal from each retail computing device 30 indicative of financial transactions associated with the owner account and/or account identifier 94, and calculates a retail transaction cost associated with the owner account based at least in part on the received financial transactions.

In the exemplary embodiment, once parking validation device 50 has identified the energy cost and the parking cost associated with account identifier 94, parking validation system 32 determines an account balance. In addition, parking validation device 50 identifies the retail transaction costs associated with account identifier 94, and determines whether the retail transaction cost is equal to, or greater than, a predefined retail transaction cost. If the retail transaction cost meets, or exceeds a predefined threshold amount, at least a portion of the account balance associated with account identifier 94 will be credited, or waived. In addition, upon determining the predefined threshold amount for the retail transaction to be met, parking validation system 32 will notify customer 28 that the predefined threshold amount has been met, and that the energy costs and/or parking costs associated with the owner account and/or account identifier 94 has been waived. In one embodiment, parking validation system 32 may notify customer 28 when the amount of retail transactions are equal to a predefined portion of the threshold amount, and notify customer 28 of a remaining amount of purchases to be made such that the energy cost and/or parking cost may be waived.

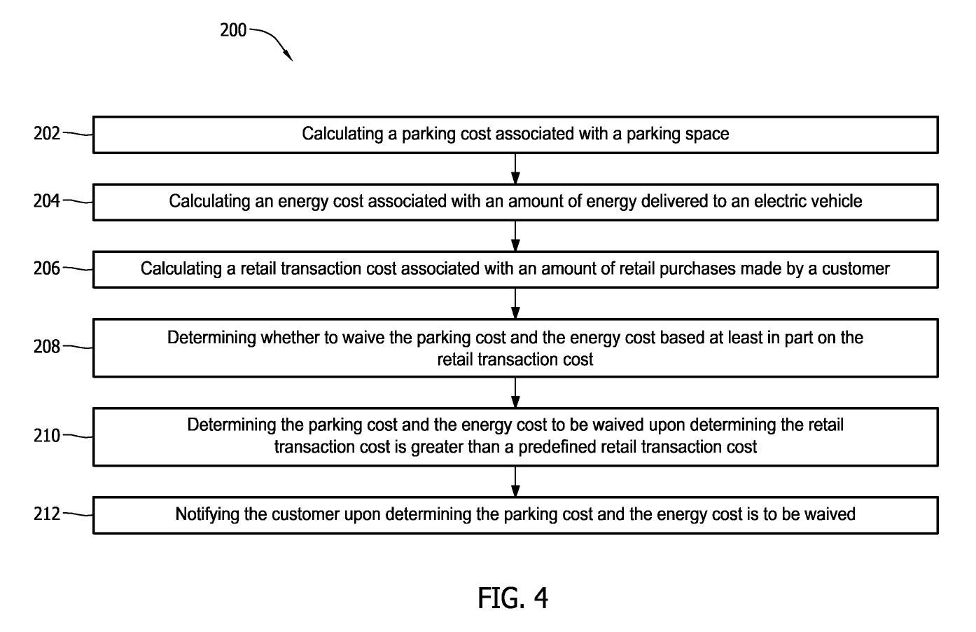

FIG. 4 is a flow diagram of an exemplary method 200 of delivering power to electric vehicle 12. In the exemplary embodiment, method 200 includes calculating 202, by parking validation device 50, a parking cost associated with a parking space 18 used by electric vehicle 12. Parking validation device 50 also calculates 204 an energy cost associated with an amount of energy delivered by charging device 16 to electric vehicle 12. In addition, parking validation device 50 calculates 206 a retail transaction cost associated with an amount of retail purchases made by customer 28 at one or more commercial retail stores 26. Moreover, parking validation device 50 determines 208 whether to waive at least one of the calculated parking cost and the calculated energy cost based at least in part on the calculated retail transaction cost. Method 200 also includes determining 210 at least one of the calculated parking cost and the calculated energy cost to be waived upon determining the calculated retail transaction cost is greater than or equal to a predefined retail transaction cost. Parking validation device 50 also notifies 212 customer 28 upon determining at least one of the calculated parking cost and the calculated energy cost is to be waived.

Method 200 also includes receiving a request to access parking area 14 for use by electric vehicle 12, determining a user account associated with electric vehicle 12, and permitting access to parking area 14 after determining the user account. In addition, method 200 includes receiving a request to deliver power to electric vehicle 12, and delivering power to electric vehicle 12 after verifying the user account associated with electric vehicle 12. Moreover, parking validation device 50 calculates the parking cost and the energy cost associated with the user account.

In the exemplary embodiment, method 200 also includes transmitting, to each commercial retail store 26, a retail transaction verification request including financial transactions associated with the user account. An indication of the financial transactions associated with the user account is received from each commercial retail store 26. Parking validation device 50 calculates the retail transaction cost based at least in part on the received financial transactions associated with the user account.

In one embodiment, method 200 includes receiving a request to access parking area 14 for use by electric vehicle 12, determining a user account associated with electric vehicle 12, and permitting access to parking area 14 after determining the user account. In addition, method 200 includes receiving a request to deliver power to electric vehicle 12, and delivering power to electric vehicle 12 after verifying the user account associated with electric vehicle 12. Moreover, parking validation device 50 calculates the parking cost and the energy cost associated with the user account.

The above-described systems and methods overcome at least some disadvantages of known parking monitoring systems by providing a parking validation system that determines an energy cost associated with a delivery of energy to the electric vehicle, and determines a parking cost associated with use of the parking area by electric vehicle. In addition, the parking validation device determines a retail transaction cost and waives at least a portion of the energy cost and/or the parking cost based on the retail transaction cost. By providing a parking area that includes a charging device and a parking validation system that determines a parking cost, an energy cost, and a retail transaction cost, a customer of the retail store is incentivized to patronize the retail store and to utilize the parking area. As a result, a revenue generated by the parking area and charging device is facilitated to be increased.

Exemplary embodiments of a system and method for use in delivering energy to an electrically powered vehicle are described above in detail. The system and methods are not limited to the specific embodiments described herein, but rather, components of the charging device and/or system and/or steps of the method may be utilized independently and separately from other components and/or steps described herein. For example, the parking validation system may also be used in combination with other power systems and methods, and is not limited to practice with only the electric vehicle as described herein. Rather, an exemplary embodiment can be implemented and utilized in connection with many other parking system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of delivering energy to an electric vehicle with a charging device positioned within a parking area having a plurality of parking spaces, said method comprising:
calculating, by a parking validation device, a parking cost associated with a parking space used by the electric vehicle;
calculating an energy cost associated with an amount of energy delivered by the charging device to the electric vehicle;
calculating a retail transaction cost associated with an amount of retail purchases made at one or more commercial retail stores;
determining whether to waive at least one of the calculated parking cost and the calculated energy cost based at least in part on the calculated retail transaction cost.

2. A method in accordance with claim 1, further comprising determining at least one of the calculated parking cost and the calculated energy cost to be waived upon determining the calculated retail transaction cost is greater than or equal to a predefined retail transaction cost.

3. A method in accordance with claim 1, further comprising notifying a user of the electric vehicle upon determining at least one of the calculated parking cost and the calculated energy cost is to be waived.

4. A method in accordance with claim 1, further comprising calculating the parking cost based at least in part on the duration of use by the electric vehicle of the parking space.

5. A method in accordance with claim 1, further comprising:
receiving, by the parking validation device, a request to access the parking area for use by the electric vehicle;
determining a user account associated with the electric vehicle;
permitting access to the parking area after determining the user account; and
calculating the parking costs associated with the user account.

6. A method in accordance with claim 5, further comprising:
receiving a request to deliver power to the electric vehicle;
delivering power to the electric vehicle after verifying the user account associated with the electric vehicle; and
calculating the energy cost associated with the user account.

7. A method in accordance with claim 5, further comprising:
transmitting, to the commercial retail stores, a retail transaction verification request including financial transactions associated with the user account;
receiving an indication from each commercial retail store of the financial transactions associated with the user account; and
calculating the retail transaction cost based at least in part on the received financial transactions associated with the user account.

8. A power delivery system for use in charging an electric vehicle, said power delivery system comprising:
at least one charging device positioned within a parking area including a plurality of parking spaces, said charging device configured to be electrically coupled to an electric vehicle for delivering energy to the electric vehicle; and
a parking validation device coupled to said charging device, said parking validation device configured to:
calculate a parking cost associated with a parking space used by the electric vehicle;
calculate an energy cost associated with an amount of energy delivered to the electric vehicle;
calculate a retail transaction cost associated with an amount of retail purchases made at one or more commercial retail stores; and
determine whether to waive at least one of the calculated parking cost and the calculated energy cost based at least in part on the calculated retail transaction cost.

9. A power delivery system in accordance with claim 8, wherein said parking validation device is further configured to determine at least one of the calculated parking cost and the calculated energy cost to be waived upon determining the calculated retail transaction cost to be greater than or equal to a predefined retail transaction cost.

10. A power delivery system in accordance with claim 8, further comprising a notification device configured to transmit, to a user of the electric vehicle, a validation message including a waiver of at least one of the calculated parking cost and the calculated energy cost.

11. A power deliver system in accordance with claim 8, wherein the parking validation device is further configured to calculate the parking cost based at least in part on the duration of use by the electric vehicle of the parking space.

12. A power delivery system in accordance with claim 8, wherein said parking validation device is further configured to:
receive a request to access the parking area for use by the electric vehicle;
determine a user account associated with the electric vehicle;
permit access to the parking area after determining the user account; and
calculate the parking costs associated with the user account.

13. A power delivery system in accordance with claim 12, wherein said parking validation device is further configured to calculate the energy cost associated with the user account.

14. A power delivery system in accordance with claim 12, wherein said parking validation device is further configured to:
transmit, to the commercial retail stores, a retail transaction verification request including financial transactions associated with the user account;
receive an indication from each commercial retail stores of the financial transactions associated with the user account; and
calculate the retail transaction cost associated with the user account based at least in part on the received financial transactions associated with the user account.

15. A parking validation device coupled to a plurality of charging devices for use in delivering power to an electric vehicle, said parking validation device comprising a processor coupled to a database, said processor programmed to:
calculate a parking cost associated with a parking space used by the electric vehicle;
calculate an energy cost associated with an amount of energy delivered to the electric vehicle by a charging device;
calculate a retail transaction cost associated with an amount of retail purchases made at one or more commercial retail stores; and
determine whether to waive at least one of the calculated parking cost and the calculated energy cost based at least in part on the calculated retail transaction cost.

16. A parking validation device in accordance with claim 15, wherein said processor is further programmed to determine at least one of the calculated parking cost and the calculated energy cost to be waived upon determining the calculated retail cost is greater than or equal to a predefined retail transaction cost.

17. A parking validation device in accordance with claim 15, wherein said processor is further programmed to notify a user of the electric vehicle upon determining at least one of the calculated parking cost and the calculated energy cost is to be waived.

18. A parking validation device in accordance with claim 15, wherein said processor is further programmed to determine a user account associated with the electric vehicle, and calculate the parking costs associated with the user account.

19. A parking validation device in accordance with claim 18, wherein said processor is further programmed to:
receive a request to deliver power to the electric vehicle;
deliver power to the electric vehicle after determining the user account associated with the electric vehicle; and
calculate the energy cost associated with the user account.

20. A parking validation device in accordance with claim 19, wherein said processor is further programmed to:
transmit, to the commercial retail stores, a retail transaction verification request including financial transactions associated with the user account;
receive an indication from each commercial retail store of financial transactions associated with the user account; and
calculate the retail transaction cost based at least in part on the received financial transactions associated with the user account.
